(19) United States
(12) Patent Application Publication
(10) Pub. No.: US 2004/0258411 A1
(43) Pub. Date: Dec. 23, 2004

(54) Node for an optical network

(75) Inventors: Daniel Al-Salameh, Marlboro, NJ (US); Peter David Roorda, Ottawa (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/862,683

(22) Filed: Jun. 7, 2004

Related U.S. Application Data
(60) Provisional application No. 60/480,374, filed on Jun. 20, 2003.
(60) Provisional application No. 60/491,404, filed on Jul. 31, 2003.

(51) Int. Cl. H04J 14/02

(52) U.S. Cl. 398/83

(57) ABSTRACT

The architecture for a photonic transport network node provides for pass-through of selected channels in the absence of OEO conversion, dropping of selected other channels, and selective routing of the other dropped channels to a processing means that provides OEO conversion and 3R processing. Conveniently, these dropped channels may be multiplexed back into the switching fabric of the node to be directed in pass-through mode to any selected output destination port. The add channels are inserted at the input side of the node. In addition, a pass-through channels may selectively delayed and OEO converted if signal conditioning and/or wavelength conversion are required. The transponders, regenerators and transceivers need not be wavelength specific, allowing flexible and scaleable network configurations. This network node is upgradeable and can be augmented without disturbing traffic within the node.

### CROSS-REFERENCE TO RELATED APPLICATIONS

The present invention claims priority from U.S. patent application Ser. Nos. 60/480,374 filed Jun. 20, 2003 and 60/491,404 filed Jul. 31, 2003, which are incorporated herein by reference.

### FIELD OF THE INVENTION

The invention is directed to a telecommunication network, and in particular to an upgradeable node architecture for a photonic transport network.

### BACKGROUND OF THE INVENTION

Expansion of optical communication networks has been fueled by data traffic and is estimated to be quite significant. Particularly, since the popularity of the World Wide Web has enabled business transactions over the Internet, IP (Internet Protocol) and IP-based services have grown and evolved dramatically.

The flexibility of most current networks comes at the expense of cost and scalability. Network flexibility is delivered electronically, and thus requires termination of photonic layer, using optical-electrical-optical (OEO) interfaces. 65-70% of nodal OEO is for managed pass-thru, or so-called hidden regenerators. There is a need to improve network scalability and to eliminate unnecessary input/output occurrences. There is also a need to improve the agility and flexibility of the network while eliminating/reducing the number of hidden regenerators.

Today, service activation time, or “time to bandwidth” (TTB), or “time-to-service” (TTS) is constrained by the physical network layer (dense wavelength division multiplexed D/WDM for optical networks) using point-to-point (pt-pt) connectivity. Cost and TTB reduction seem to be mutually exclusive for this type of connectivity. There is a need to disassociate these two parameters to fully utilize the benefits of WDM.

Also, network engineering and planning are currently very complex, time consuming and thus expensive. For example, there are approximately 400 card types per vendor to be installed at a node, due to the cards being wavelength specific. There are three types of networks (access, metro and transport) each with off-line planning. This results in growing nodal connection complexity, which results in increased network management complexity, and scalability problems. As well, the system turn-up grows more and more complex, involving extensive simulation, engineering and testing. There is a need to simplify network engineering and planning.

It is an object of the invention to provide a node architecture for an optical network, which alleviates totally or in part the drawbacks of the prior art network architectures.

Circuit or packet based optical network services requires connectivity from any point to any other point in the network based on which network nodes are established, where access to each node can be from one or more direction.

The quality of service and network survivability requires diverse routing to allow for re-routing traffic around a failure of any link or any node.

It is an object of this invention to provide a robust node architecture that will conveniently allow for this diverse routing so that a desired interconnectivity can be achieved.

An aspect of the instant invention provides a network node architecture that supports at least two conversion routes carrying one or more input and output signals.

### SUMMARY OF THE INVENTION

Accordingly, the invention provides a network node for routing a channel from an input side to an output side through an intermediate switching node or broadcast transmission/blocking node connected along a transmission path, comprising a wavelength selective element (WSE) having n input ports and n or m output ports wherein at least one input port and at least one output port have a multiplexer and demultiplexer respectively optically coupled thereto, and wherein processing means, such as OEO and 3R means are disposed between and communicate with the demultiplexer for receiving channels therefrom and the multiplexer for providing processed channels to the WSE.

In accordance with a further aspect of the invention, the network node is capable of routing any incoming channel through to an outbound port in the absence of OEO conversion, or alternatively, the network node is capable of selectively directing any incoming channel to an OEO processing unit to be routed back to the WSE where the channel can selectively be routed to any outgoing port.

In accordance with a broad aspect of the invention a node is provided having a ROADM coupled to a multiplexer at its input port and coupled to a demultiplexer at its output port. A processing means for providing some signal processing is disposed between the demultiplexer and the multiplexer.

In one embodiment the ROADM can include an MWS and in other embodiments may comprise wavelength blockers.

In accordance with an aspect of the invention there is provided, an optical node for connection to a network for receiving incoming signals and for sending outgoing signals having a plurality of wavelength channels. The node includes

a least one reconfigurable wavelength selective element having n+k input ports and m+l output ports for switching selectively any wavelength channel from any input port to any output port wherein;

at least some of the n input ports are optically coupled to receive from the network optical signals having a plurality of wavelength channels and;

at least some of the m output ports are optically coupled to send to the network optical signals having a plurality of wavelength channels and;

at least the kth input port is optically coupled to a local add multiplexer for receiving wavelength channels from with in the node and combining them into a single optical signals having a plurality of wavelength channels;

at least the lth output port is optically coupled to a local drop demultiplexer for receiving an optical signal having a plurality of wavelength channels that have not passed through from one of n input ports to one of the n output ports and for demultiplexing said optical signal into individual wavelength channels; and

means disposed between and optically coupled with the local drop demultiplexer and the local add multiplexer for processing at least one channel demultiplexed by the local drop demultiplexer and providing a least a channel corresponding to said at least one channel to the local add multiplexer.

### BRIEF DESCRIPTION OF THE DRAWINGS

Exemplary embodiments of the invention will now be described in conjunction with the drawings in which:

FIG. 1 is a schematic drawing of a scalable optical node in accordance with a first embodiment of the invention, wherein incoming channels may be selectively passed through or selectively dropped and processed for 3R conversion by way of being reshaped, retimed or re-generated.

FIG. 2 is a more detailed schematic drawing of the optical node shown in FIG. 1 including additional circuitry providing a more functional optical node with increased capability.

FIG. 3 is a high level schematic of the node shown in FIG. 2.

FIG. 4 is a prior art architecture of a node having add ports that cannot be routed though the ROADM for selective switching back through the node.

FIG. 5 is a schematic drawing of a node similar to that shown in FIG. 1, and wherein the ingress of the ROADM is a multi-wavelength switch coupled to a plurality of combiners.

FIG. 6 is a schematic block diagram illustrating an embodiment of the invention where two back-to-back MWSs serve as a ROADM within this architecture.

FIG. 7 is a schematic block diagram wherein MWSs are provided at the input to the ROADM to locally add channels, and;

FIG. 8 is a schematic block diagram with fewer blockers within the ROADM.

### DETAILED DESCRIPTION

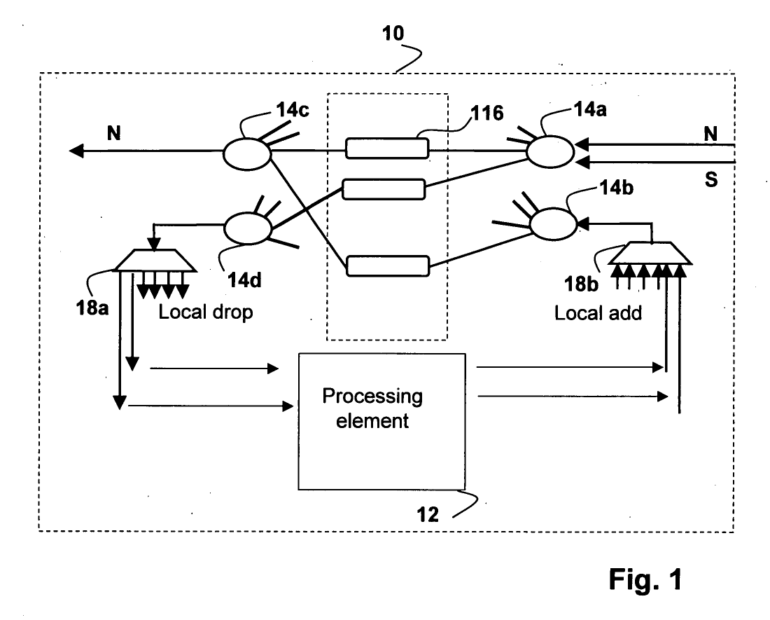

Referring now to FIG. 1, a reconfigurable optical node 10 is shown in accordance with a first embodiment of the invention.

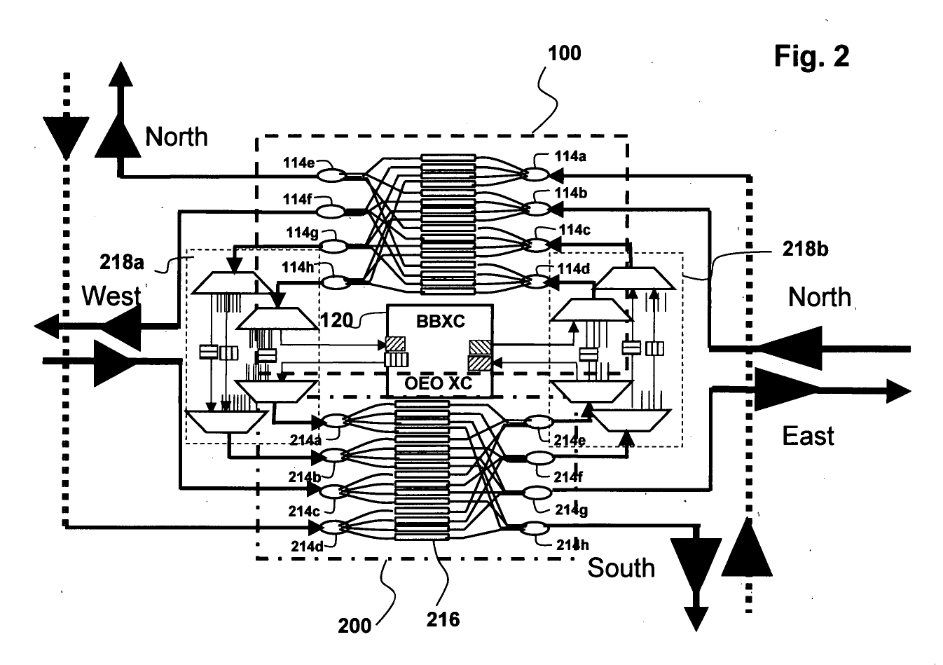

Two incoming multiplexed waveguides labeled N, S, in the form of optical fibers are shown as entering the node from the right side; each of the fibers transport optical signals comprising a plurality of optical channels multiplexed therein. For example, the uppermost input fiber is shown to have traffic incoming from the North (N) and the lowermost input fiber is carrying traffic from the South (S). Conveniently, any single channel within a multiplexed signal propagating on either of the North or South incoming fibers can be routed through to the outgoing North port or alternatively can be routed through the processing element 12 for 3-R processing. Splitters 14a, and 14b perform the function of passively routing oncoming signals carrying multiple channels to all of their output ports in a broadcast fashion, and combiners 14c and 14d oppositely combine all signals on their input ports to respective single output ports. A group of three reconfigurable wavelength selective elements 16 each having an input port and output port are disposed to receive all signals from the output ports of the splitters 14a and 14b and can selectively pass or block certain channels in such a manner as to selectively route any channel to the North output port or the local drop demultiplexer 18a. The splitters 14a, 14b, combiners 14c and 14d and the wavelength selective elements 16 together form a 2-D (2 direction) reconfigurable add-drop module ROADM that can be augmented from 2-D to 4-D by adding additional wavelength selective elements, combiners and splitters. Hence, this node is upwardly scalable such that additional input and output ports can be added without disturbing the operation of the system. This is more evident from FIG. 2, where 4 input ports and 4 output ports are provided for handling traffic coming from North, East, South and West while providing the ability to route any channel on any of the NEWS ports for processing by way of 3-R or other types of processing as required. Referring once again to FIG. 1 a processing element 12 is disposed between a demultiplexer 18a and a multiplexer 18b. The critical placement of these three elements allows a channel routed to the demultiplexer 18a to be processed by the processing element and to be routed back into the input side of the node 10 in a similar fashion to other incoming traffic. This novel route of sidetracking a particular selected channel, processing it and routing in back in to be directed to any outgoing port offers a great deal of flexibility to the user of this node. Furthermore, the provision of splitters and combiners with wavelength selective elements therebetween offers upward or downward scalability, as may be required.

Turning now to FIG. 2, a more complex system utilizing the core node in FIG. 1 is shown.

On the right side of the node, incoming signals to the node from the North and South are shown, wherein each of the four splitters 114a, 114b, 114c and 114d on the input side, have only a single incoming fiber carrying incoming traffic. In this configuration even incoming traffic from two different locations carrying channels having a same center wavelength can be routed to any of the NEWS output ports or can be routed for processing by the processing element disposed between and optically coupled to the demultiplexer/multiplexer 218a and multiplexers/demultiplexer 218b respectively. It should be noted that in the configuration shown, incoming channels from the North that are destined for the South output port must be demultiplexed and re-multiplexed by the demultiplexer/multiplexer 218a. The second wavelength selective element 200 includes four 1×n splitters 214a, 214b, 214c, and 214d, four n×1 combiners 214e, 214f, 214g, and 214h and sixteen wavelength selective blockers 216 disposed therebetween; this element 200 selectively routes incoming traffic accordingly, and hence the selected channels in this instance would be passed to the South port. This particular embodiment economizes on the number of direct routes lessening the number of components required, however provision of a direct North South or North East pass through capability could be provided utilizing a greater number of nodes within the wavelength selective element (WSE) 100. For example a n×n WSE is shown, wherein an n×m could be provided with m>n, or alternatively a n×n wherein n is sufficiently large to accommodate NEWS input and output pass through ports.

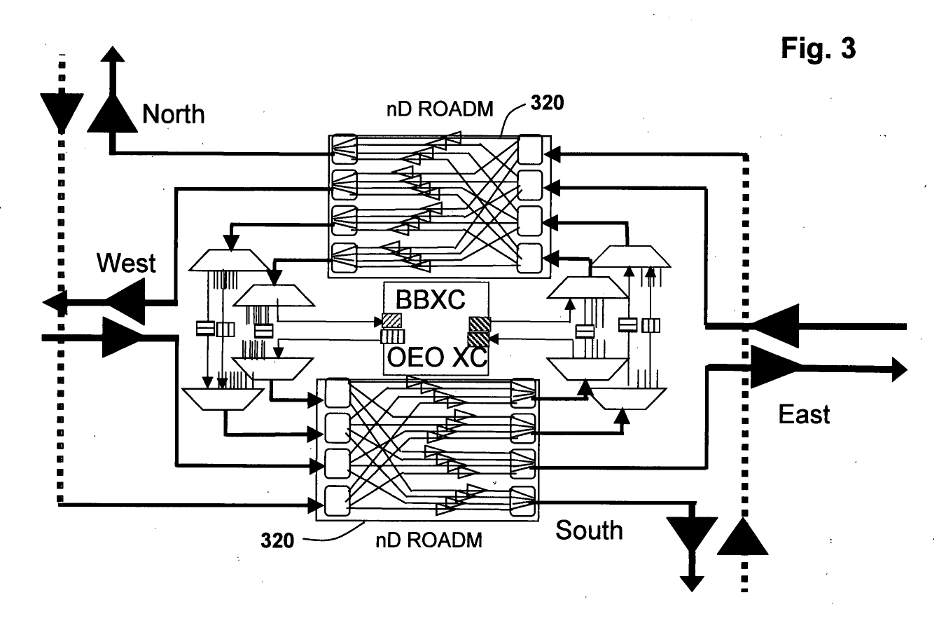

FIG. 3 is a high level diagram of the node shown in FIG. 2., wherein the wavelength selective element is shown to be a reconfigurable add, drop module (ROADM). The ROADM 320 can include 1:4 star couplers optically coupled with a multi-wavelength switch (MWS). Notwithstanding the number of input and output ports of the ROADM 320 can be greatly increased if desired and accordingly the number of ports on the couplers, etc. would have to be increased as well. The MWS provides the selective routing of a multiplexed input signal to any output port. The MWS can be implemented using free space technology or can be fabricated with a planar lightwave circuit (PLC). This node provides route-to-route pass through in the optical domain with 3R and or wavelength conversion. Furthermore, amplification can be provided within the ROADM 320 or alternatively can be provided by the processing module. This circuit provides for selected local add drop, wherein any channel can be selectively added or dropped, and power level control and compensation is provided within either the processing means or within the ROADM 320.

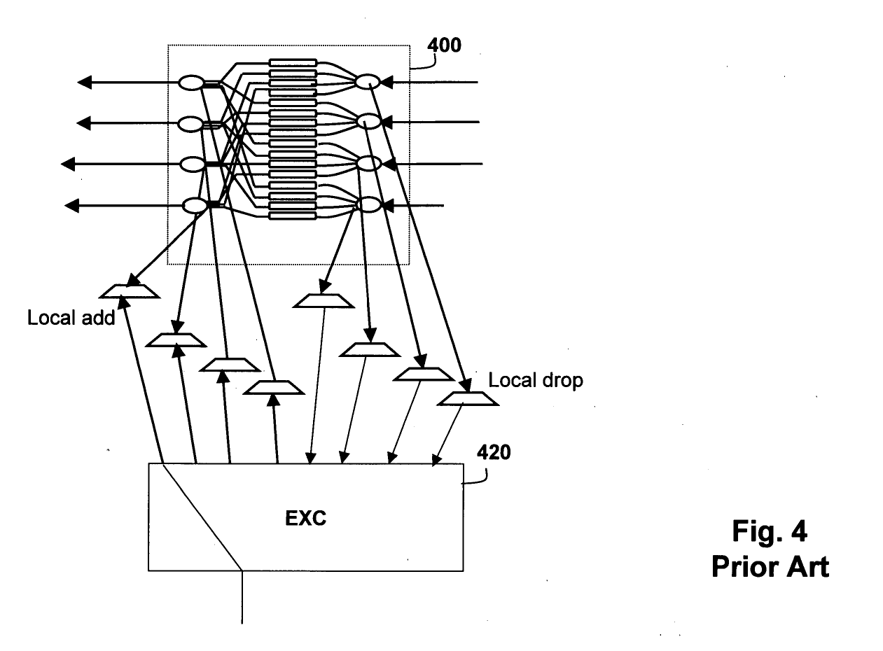

In contrast with FIGS. 1 through 3, a prior art node is shown in FIG. 4 wherein local add and drop ports are direction bound through a cross connect switch 420. The ROADM 400, which can be in the form of a wavelength blocker or a multiwavelength switch (MWS), performs path switching, however add and drop ports are not routed and switched through the ROADM 400. This node architecture is quite limited in comparison with the node shown in FIG. 3, whereby add channels can be added into the ROADM 320 and then selectively routed to a desired destination by the ROADM 320.

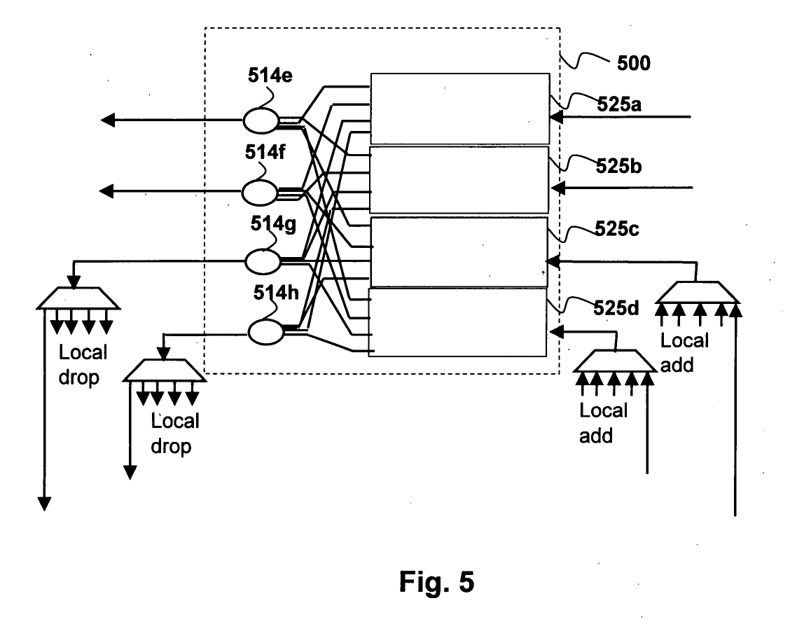

Turning once again to the instant invention, FIG. 5 illustrates an embodiment of the ROADM 500 configured by coupling into the ROADM with ingress MWSs 525a through 525d. Egress couplers 514e through 514h are coupled to the MWSs.

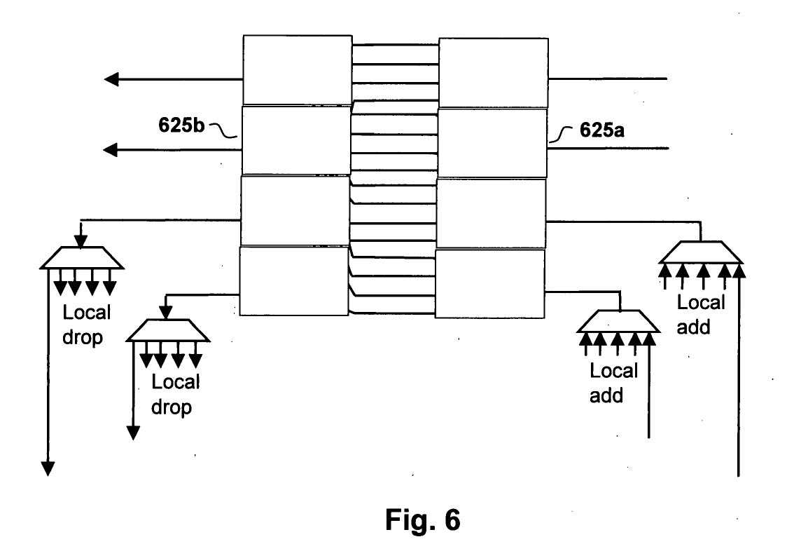

Alternatively, four ingress splitters can be used at the input end coupled to an MWS at the output end of the ROADM. In another embodiment shown in FIG. 6, which is more costly, but imposes less signal loss, two MWS modules 625a and 625b can be coupled back-to-back to provide the desired ROADM functionality.

This embodiment of the invention provides the ability for signals entering the node from the local add ports to be routed selectively back to the local add ports. This feature is commonly referred to as hairpinning and is a key requirement in a number of telecommunications applications. Furthermore, the node allows signals entering the node on an input port from a direction to be routed directly to the output port of the same direction, for example North input to North output. This feature is commonly referred to as loopback, and again, is often a required feature of a telecommunications node.

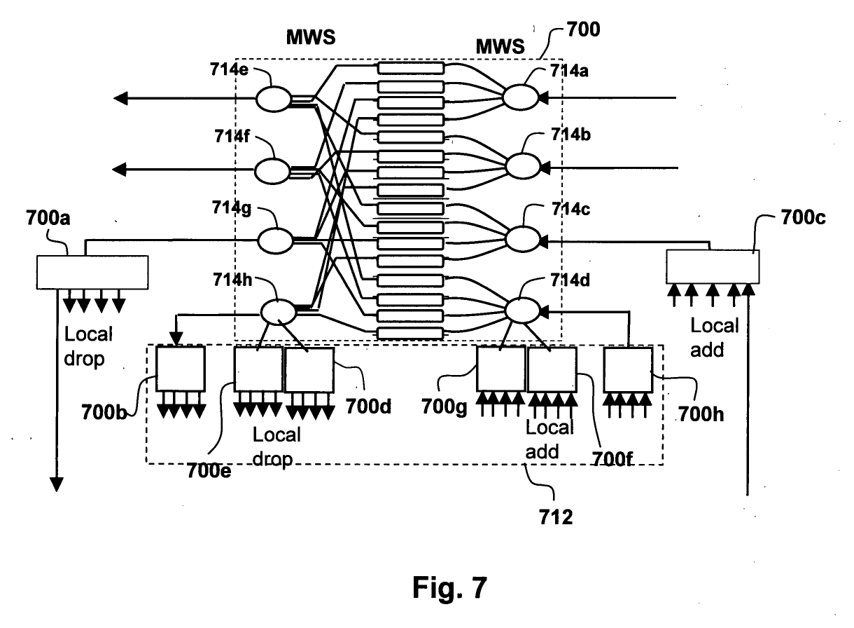

FIG. 7 illustrates an embodiment of the invention similar to those shown heretofore, in accordance with the invention, wherein MWS modules 712 are provided at the input and output of the ROADM 700. Each of the MWS modules within block 712 couple into the ROADM via star couplers, which act to combine distinct wavelengths from each of the MWS modules. This embodiment provides a number of advantages. It allows each wavelength to be routed selectively not only to the desired ROADM output port, but also selectively to the desired local drop port. It also allows input channels from tunable lasers to be routed dynamically into the ROADM. Finally, the use of multiple input and output ports of the star coupler allows a large number of subtending mux/demux ports to be support despite a limitation on the number of ports of an individual MWS. Local drop functionality is provided by MWS 700a, 700b, 700e, and 700d whereby local add input ports are provided by MWS 700c, 700g, 700f, and 700h. These MWSs functionally allow any multiplexed input group of channels to be selectively routed to any of the MWS output ports on any given MWS. One novel aspect of this arrangement is that the star couplers, 714h and 714d have multiple input and multiple output ports whereby plural MWS blocks are coupled to each of the star couplers. For example star coupler or combiner 714h is shown to have 4 input ports and three MWSs 700b, 700e and 700d directly coupled to the output ports, providing plural local drop ports.

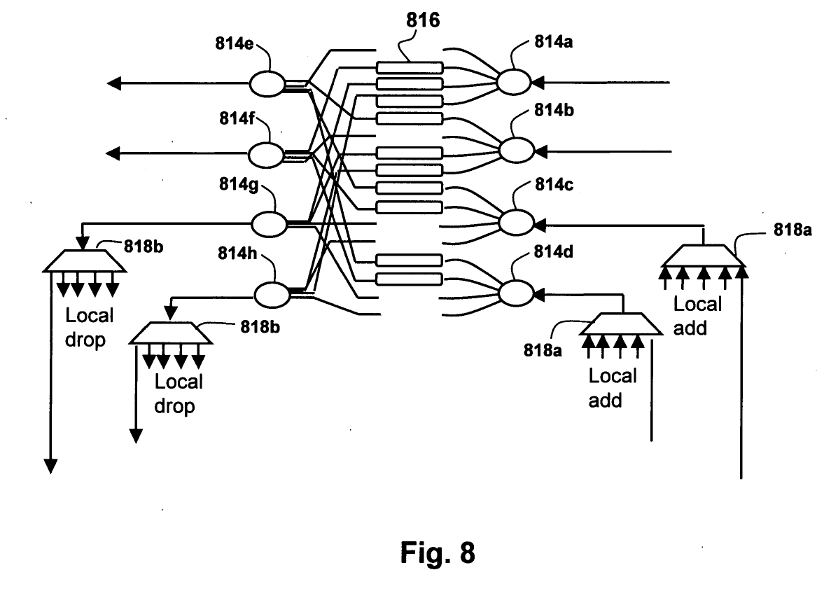

FIG. 8 shows a node in accordance with an embodiment of the invention wherein fewer blockers are required as the hairpin and loopback functionality provided in previous embodiments are not provided for here. A plurality of express ports is provided in addition to two local add/drops. For simplicity, the processing module is not shown coupled between the drop and add demultiplexer multiplexer respectively. Splitters 814a through 814d are coupled via blockers 816 to couplers 814e through 814h.

Of course numerous other embodiments may be envisaged, without departing from the spirit and scope of the invention.

What is claimed is:

1. An optical node for a network, capable of selectively passing incoming signals comprising a plurality of wavelength channels therethrough in the absence of converting from O-E-O, said optical node further being capable of selectively adding external channels or dropping individual channels within the incoming signals from the node, the optical node comprising:
a first wavelength selective element (WSE) having at least n input ports and m output ports, wherein n and m are greater or equal to 2, said WSE for selectively routing any of at least p channels received on one of the n input ports to any of m output ports, at least one of the n input ports P_{add}_{_{—}}_{local} for receiving local add channels from within the node, and at least one of the m output ports p_{drop-local} for routing one or more received channels from any one of the n input ports to the at least one input port p_{add}_{_{—}}_{local} after “massaging” said at least one or more received channels; and,
a processing element for massaging at least a channel received from the output port p_{drop-local} and for providing said at least channel to the input port p_{add}_{_{—}}_{local}, wherein massaging includes at least one of attenuating, amplifying, reshaping and converting said channel from an optical to electrical to optical channel.

2. An optical node for a network as defined in claim 1, further comprising wavelength multiplexing means for combining one or more channels received from the processing element and for providing said one or more channels to the input port ports p_{add}_{_{—}}_{local}.

3. An optical node for a network as defined in claim 2, further comprising wavelength demultiplexing means for separating one or more multiplexed channels received from the first WSE into one or more separate channels for provision on separate waveguides to be provided to the processing element.

4. An optical node for a network as defined in claim 1 wherein the first WSE is comprised of a plurality of n splitters having output ports and m combiners having input ports and means disposed between the n splitters and m combiners coupled to receive signals in the form of multiplexed channels from the n splitter output ports and to controllably provide selected channels to any of the m combiners input ports.

5. An optical node for a network as defined in claim 3, wherein the first WSE includes splitters, combiners and wavelength blockers there between, for allowing selected channels to pass from any splitter to any combiner, and to block selected channels from passing between selected paths between any splitter and any combiner.

6. An optical node as defined in claim 1, wherein any local added channel that has passed through the processing element and subsequently provided to input port P_{add}_{_{—}}_{local} can be routed to any of the m output ports.

7. An optical node as defined in claim 1, wherein n and m are both greater or equal to 4 and wherein at least two of the m output ports are pass through ports such that traffic provided to the at least two m ports from any of the n input ports is routed out of the first WSE without being directed through the processing element.

8. An optical node as defined in claim 3 further comprising a second wavelength selective element (WSE) having at least n input ports and m output ports, wherein n and m are greater or equal to 2, said second WSE for selectively routing any of at least p channels received on one of the n input ports to any of the m output ports at least one of the n input ports being optically coupled to receive channels from the wavelength demultiplexing means, at least on of the m output ports being optically coupled to the wavelength multiplexing means for providing selected channels thereto.

9. An optical node as defined in claim 3, wherein the first WSE is comprised of an ingress multi-wavelength switch having n input ports and m×n output ports optically coupled with a combiner having n×m input ports and m output ports.

10. An optical node as defined in claim 3, wherein the first WSE is comprised of an ingress optical splitter having n input ports and n×m output ports optically coupled with a multi-wavelength switch having n×m input ports and m output ports.

11. An optical node as defined in claim 3, wherein the first WSE is comprised of ingress and egress back to back multi-wavelength switches (MWSs), the ingress MWS having n input ports and the egress MWS having m output ports, the ingress and egress MWSs both having n×m optical connections therebetween.

12. An optical node as defined in claim 9 wherein the multiplexing means and demultiplexing means are colourless so as that the multiplexing means can route any selected channel of a group of channels routed therein to any output port on the multiplexing means, and so that the demultiplexing means can combine any channel present on any of its input ports to a single output port.

13. An optical node as defined in claim 3 wherein n=m and wherein n>3.

14. An optical node as defined in claim 1, wherein at least two input ports are optically coupled to colourless local add multiplexers, and wherein at least two output ports are optically coupled to two colorless local drop demultiplexers and wherein one of the colorless demultiplexers and one of the colourless multiplexers are optically coupled through the processing element.

15. An optical node as defined in claim 3, wherein the processing element includes and O-E-O converter.

16. An optical node as defined in claim 14, wherein the processing element includes a regenerator having a tunable laser.

17. An optical node as defined in claim 3 wherein the processing means includes means to convert a wavelength of an incoming signal to another wavelength.

18. An optical node for connection to a network for receiving incoming signals and for sending outgoing signals having a plurality of wavelength channels, said node comprising:
a least one reconfigurable wavelength selective element having n+k input ports and m+l output ports for switching selectively any wavelength channel from any input port to any output port wherein;
at least some of the n input ports are optically coupled to receive from the network optical signals having a plurality of wavelength channels and;
at least some of the m output ports are optically coupled to send to the network optical signals having a plurality of wavelength channels and;
at least the kth input port is optically coupled to a local add multiplexer for receiving wavelength channels from with in the node and combining them into a single optical signals having a plurality of wavelength channels;
at least the lth output port is optically coupled to a local drop demultiplexer for receiving an optical signal having a plurality of wavelength channels that have not passed through from one of n input ports to one of the n output ports and for demultiplexing said optical signal into individual wavelength channels; and
means disposed between and optically coupled with the local drop demultiplexer and the local add multiplexer for processing at least one channel demultiplexed by the local drop demultiplexer and providing a least a channel corresponding to said at least one channel to the local add multiplexer.

19. An optical node as defined in claim 18, wherein the means for processing includes an optical-electrical-optical conversion unit for providing 3-R conversion.

20. An optical node as defined in claim 4 wherein at least one of the m combiners have at least two output ports, each coupled to a different multi-wavelength switch and wherein at least one of the m splitters have at least two input ports each coupled to a different multi-wavelength switch for providing local drop and local add functionality, respectively.

21. An optical node as defined in claim 8, wherein the means for processing includes an optical-to-electrical-to-optical (OEO) conversion circuit for providing any selected channel within the node with any of regeneration, retiming, or reshaping (3-R).
